(19) United States
(12) Patent Application Publication
(10) Pub. No.: US 2025/0057199 A1
(43) Pub. Date: Feb. 20, 2025

(54) METHOD OF PREPARING LOW-SALT PICKLES USING CITRON VINEGAR

(71) Applicant: Damwoo Agricultural Co., Ltd, Goheung-gun (KR)

(72) Inventor: Yun Suk MO, Goheung-gun (KR)

(21) Appl. No.: 18/482,851

(22) Filed: Oct. 7, 2023

(30) Foreign Application Priority Data
Aug. 16, 2023 (KR) 10-2023-0106836

(51) Int. Cl. A23L 19/20; A23L 23/00; A23L 27/10

(52) U.S. Cl. CPC A23L 19/20; A23L 23/00; A23L 27/10

(57) ABSTRACT

Disclosed is a method of preparing low-salt pickles using citron vinegar, including (1) preparing vegetable broth by boiling bay leaves, green onion roots, and red pepper seeds in water and performing filtration, (2) preparing a pickled intermediate through primary pickling by adding food materials for pickles to the vegetable broth, the temperature of which is maintained at 40 to 50° C., and performing aging for 5 to 10 days, (3) preparing a pickling solution by mixing soy sauce, sugar, fermented Korean plum liquid, alcohol, and mixed vinegar and performing aging, and (4) preparing low-salt pickles through secondary pickling by mixing the pickled intermediate with the pickling solution and performing aging. The low-salt pickles can be used by various people without objection and are beneficial to health due to low sodium content.

### CROSS REFERENCE TO RELATED APPLICATION

The present application claims priority to Korena Patent Application No. 10-2023-0106836, filed on Aug. 16, 2023, the entire contents of which are incorporated herein for all purposes by this reference.

### BACKGROUND OF THE INVENTION

### Field of the Invention

The present invention relates to a method of preparing low-salt pickles using citron vinegar, and more particularly to a method of preparing low-salt pickles using citron vinegar, which may be used by various people without objection, may be stored for a long period of time, and has low sodium content.

### Description of the Related Art

Pickles are a kind of pickled food eaten in seasons when vegetables are scarce after storage of common seasonal vegetables for a long period of time in soy sauce, red pepper paste, soybean paste, salt, vinegar, etc. Pickles are an important food that supplies vitamins along with Kimchi in winter when vegetables are scarce.

Pickles supply inorganic salts such as Ca, Fe, and K needed by the human body, and prevent acidification of bodily fluids by neutralizing acids generated in the body. Moreover, pickles, which use vegetables or fruits, are an important source of fiber, and nutritional value thereof is high because various enzymes generated during the fermentation process help digestion and bacteria such as lactic acid bacteria, etc. have intestinal regulation activity.

Currently, pickle products using radishes, cucumbers, garlic, and the like are being sold on the market, and pickles using various food materials are recently being developed.

When pickles are prepared using various food materials in this way, it is very important to select and add a sauce capable of pairing well with the unique taste of the relevant food material, and is also important to satisfy palatability by adjusting salinity, texture, color, etc.

Moreover, for long-term preservation, pickles are treated with a salty sauce such as red pepper paste or soybean paste in addition to salt or soy sauce, which causes a decrease in palatability due to a strong salty taste.

Meanwhile, citron has a thick skin and many seeds, so the yield when squeezed is around 15%, which is regarded as relatively low compared to other fruits, but citron with unique flavor and taste has been used as tea by making citron syrup by soaking the same in sugar or honey, or used as alcoholic drink, honeyed juice, rice cake, Jeonggwa, and spice.

In addition, citron is high in liquid content and has a good flavor, and is thus used as an acidulant in cooking or is effective at treating and preventing cold, neuralgia, and stroke. Furthermore, citron has been used in folk medicine in a manner in which citron seeds are burned, mixed with rice, and applied onto the affected area for skin diseases such as corns and warts and also in which decoction of citron peels is eaten for miscarriage or postpartum abdominal pain.

As described above, citron is a fruit with excellent palatability containing various medicinal ingredients.

In modern times, various types of vinegar are used, such as brewing vinegar made from grains, alcoholic beverages, fruits, etc., glacial acetic acid, synthetic vinegar made using acetic acid as the main ingredient, processed vinegar made by adding spices to brewing vinegar, and the like, and efforts are being made to produce vinegar with a variety of unique flavors.

### SUMMARY OF THE INVENTION

An object of the present invention is to provide a method of preparing low-salt pickles using citron vinegar, which may be used by various people without objection, may be stored for a long period of time, and has low sodium content.

In order to accomplish the above object, the present invention provides a method of preparing low-salt pickles using citron vinegar, including (1) preparing vegetable broth by boiling bay leaves, green onion roots, and red pepper seeds in water and performing filtration, (2) preparing a pickled intermediate through primary pickling by adding food materials for pickles to the vegetable broth, the temperature of which is maintained at 40 to 50° C., and performing aging for 5 to 10 days, (3) preparing a pickling solution by mixing soy sauce, sugar, fermented Korean plum liquid, alcohol, and mixed vinegar and performing aging, and (4) preparing low-salt pickles through secondary pickling by mixing the pickled intermediate with the pickling solution and performing aging.

The mixed vinegar may include citron vinegar and apple cider vinegar.

In addition, the present invention provides low-salt pickles using citron vinegar prepared using the method described above.

In addition, the present invention provides a dry low-salt pickle product using citron vinegar prepared by drying and pulverizing pickle solids obtained from the low-salt pickles described above.

In addition, the present invention provides a low-salt pickle solution using citron vinegar prepared by obtaining a remaining liquid after removal of pickle solids from the low-salt pickles described above.

### BRIEF DESCRIPTION OF THE DRAWING

FIG. 1 shows a process of preparing low-salt pickles using citron vinegar according to the present invention.

### DETAILED DESCRIPTION OF THE INVENTION

Hereinafter, a preferred embodiment of the present invention will be described in detail with reference to the accompanying drawing. A detailed description of well-known functions and configurations that may unnecessarily obscure the gist of the present invention will be omitted.

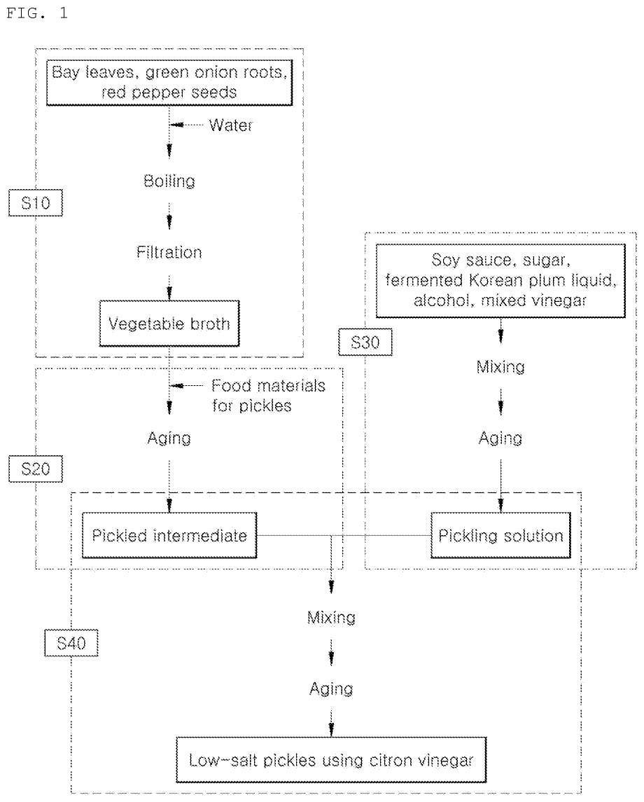

As shown in FIG. 1, a method of preparing low-salt pickles using citron vinegar according to the present invention includes preparing vegetable broth (S10), preparing a pickled intermediate (S20), preparing a pickling solution (S30), and preparing low-salt pickles (S40).

### (1) Step 1: Preparation of Vegetable Broth (S10)

In step 1, vegetable broth is prepared by boiling bay leaves, green onion roots, and red pepper seeds in water and performing filtration.

Bay leaves and red pepper seeds serve to increase shelf life of low-salt pickles to prevent the same from spoiling and deteriorating. Bay leaves and red pepper seeds not only stimulate appetite, but also add flavor to pickles, and have superior preservative effects, such that the shelf life of pickles is increased. Red pepper seeds add a bit of spiciness to create a clean and refreshing taste.

Green onion roots serve to alleviate strong flavor of food materials such as Peucedanum japonicum and Cirsium setidens so as to prepare pickles suitable for taste of various people.

Vegetable broth is preferably prepared by mixing bay leaves, green onion roots, and red pepper seeds in a weight ratio of 1:2-4:2-4 to obtain a mixture, and mixing the mixture with water in a weight ratio of 1:5-7, followed by boiling at a temperature of 100 to 120° C. for 12 to 24 hours.

The weight ratio of bay leaves, green onion roots, and red pepper seeds is optimal for maintaining long-term storage of pickles and improving flavor thereof. Based on 1 weight ratio of bay leaves, if the weight ratio of green onion roots or red pepper seeds is less than 2, storability may be decreased. On the other hand, if the weight ratio of green onion roots or red pepper seeds exceeds 4, taste and flavor may become strong, resulting in poor palatability.

If boiling is performed at a temperature lower than 100° C. or for a period of time shorter than 12 hours, active ingredients of the materials may not be sufficiently eluted, whereas if boiling is performed at a temperature higher than 120° C. or for a period of time longer than 24 hours, it may be difficult to achieve further improvement.

### (2) Step 2: Preparation of Pickled Intermediate (S20)

In step 2, a pickled intermediate is prepared through primary pickling by adding food materials for pickles to the vegetable broth prepared in step 1, the temperature of which is maintained at 40 to 50° C., and performing aging for 5 to 10 days.

Examples of the food materials for pickles may include herbs such as Peucedanum japonicum, Cirsium setidens, etc., mushrooms such as Lentinula edodes, Tricholoma matsutake, etc., vegetables such as onions, radishes, cucumbers, garlic, etc., fruits such as apples, Korean plums, etc., and leaves, roots, or barks of stems of wild plants such as Plantago asiatica, Pueraria montana var. lobata, Morus alba, Eleutherococcus sessiliflorus, Ulmus davidiana var. japonica, Luffa cylindrica, sunflower, etc. In addition, food materials for pickles may be seaweeds such as Porphyra, Undaria pinnatifida, etc.

Food materials for pickles may be used by washing with clean water after trimming, and may be cut to suit user's taste. Food materials for pickles may be washed in salt water, and roots, stems, and leaves may be selectively used depending on the characteristics of food materials.

The food materials for pickles are placed in enough water to be submerged and thus primarily pickled. Here, the temperature of the vegetable broth is maintained at 40 to 50° C., and aging is performed for 5 to 10 days, thereby obtaining the pickled intermediate.

If the temperature of the vegetable broth is lower than 40° C., the vegetable broth cannot sufficiently permeate the food materials, whereas if it exceeds 50° C., inherent properties of the food materials may be damaged. Also, if the aging period is shorter than 5 days, the time taken for the vegetable broth to permeate the food materials may be insufficient, whereas if it exceeds 10 days, improved effects cannot be expected.

### (3) Step 3: Preparation of Pickling Solution (S30)

In step 3, a pickling solution is prepared by mixing soy sauce, sugar, fermented Korean plum liquid, alcohol, and mixed vinegar and performing aging.

Generally, pickles are prepared using fish sauce. Fish sauce has a good savory taste, but it has a fishy flavor and a strong salty taste, so it is often not suitable for consumers' taste. A pickling solution may be used to make low-salt pickles having a good flavor without the use of fish sauce.

Since the vegetable broth and the pickling solution neutralize salinity through the aging process, any soy sauce may be used regardless of salinity. As necessary, salinity may be further lowered using low-salt soy sauce.

For example, low-salt soy sauce may be made using fermented soybean lumps shaped after mixing boiled mashed soybeans with Helianthus tuberosus powder and fermented soybean powder. Examples of the soybeans may include soybean, green soybean, black soybean, Rhynchosia Nulubilis, white soybean, mouse eye bean, and the like.

The fermented soybean powder is inoculated with bacteria necessary for soy sauce preparation and does not have unique smell of bacterial culture fluid. The fermented soybean powder may be prepared by immersing 100 to 200 g of soybean lysate in 1 liter of malt culture fluid, followed by fermentation at a temperature of 20 to 25° C. for 24 to 48 hours to obtain a fermented broth, which is then dried and pulverized. Here, malt may be Bacillus subtills.

Helianthus tuberosus has high inulinase activity, and gives the soy sauce a sweet taste because the enzyme decomposes inulin to produce fructose.

Boiled mashed soybeans are shaped into fermented soybean lumps after mixing with fermented soybean powder and Helianthus tuberosus powder. Soy sauce made with such fermented soybean lumps becomes low-salt soy sauce with a good flavor and good for health. Fermented soybean lumps may be prepared by mixing 100 parts by weight of boiled mashed soybeans with 6 to 10 parts by weight of Helianthus tuberosus powder and 10 to 20 parts by weight of fermented soybean powder.

Based on 100 parts by weight of boiled mashed soybeans, if the amount of Helianthus tuberosus powder is less than 6 parts by weight, it may be difficult to form fermented soybean lumps due to a watery mixture, whereas if it exceeds 10 parts by weight, malt may not be generated well. Also, if the amount of fermented soybean powder is less than 10 parts by weight, malt may not be generated well, whereas if it exceeds 20 parts by weight, soy sauce taste may be lost.

Low-salt soy sauce with a salinity of 1.5 to 2.5% may be prepared by placing fermented soybean lumps in salt water and performing aging.

Fermented Korean plum liquid may be prepared by mixing Korean plum and sugar in a weight ratio of 1:0.8-1 and performing aging for 90 to 100 days. Fermented Korean plum liquid is capable of maintaining the sugar level even when the amount of sugar is decreased and supplying healthy ingredients to provide healthy pickle food.

Also, fermented Korean plum liquid may be prepared by fermenting Korean plum with a mixed solution of Bacillus amyloliquefaciens culture fluid, microcrystalline cellulose, and dextrin, thereby extracting large amounts of functional ingredients of Korean plum and increasing antibacterial activity. Microcrystalline cellulose and dextrin serve to promote bacterial growth.

The mixed solution is preferably prepared by mixing 70 to 85 wt % of the culture fluid, 10 to 20 wt % of microcrystalline cellulose, and 1 to 10 wt % of dextrin, based on the total weight thereof. Bacillus amyloliquefaciens culture fluid increases the amount of active ingredient of Korean plum, resulting in high immune-enhancing activity.

Based on 100 wt % of the mixed solution, if the amount of the culture fluid is less than 70 wt %, there is no efficacy, whereas if it exceeds 85 wt %, the amounts of the other components may be affected. Also, if the amount of microcrystalline cellulose is less than 10 wt %, there is a problem with bacterial growth, whereas if it exceeds 20 wt %, the amounts of the other components may be affected. Also, if the amount of dextrin is less than 1 wt %, there is a problem with bacterial growth, whereas if it exceeds 10 wt %, unique taste of dextrin may cause objection.

Fermented Korean plum liquid may be prepared by adding 250 to 300 g of Korean plum to 1 liter of the mixed solution and performing fermentation at a temperature of 20 to 30° C. for 30 to 60 days. This fermented Korean plum liquid contains large amounts of beneficial ingredients of Korean plum, so it may help health and produce pickles capable of long-term preservation.

Mixed vinegar is a mixture of citron vinegar and apple cider vinegar. Citron vinegar contains large amounts of aromatic compounds, and neutralizes or removes odor with a unique citron flavor thereof, improving palatability of pickles. Apple cider vinegar promotes digestion, adds flavor to pickles, and neutralizes or eliminates odor, making pickles more palatable.

Mixed vinegar is preferably composed of citron vinegar and apple cider vinegar mixed in a weight ratio of 1:8-10. If the weight ratio of apple cider vinegar is less than 8 relative to 1 weight ratio of citron vinegar, palatability may be low due to strong flavor of citron vinegar, whereas if it exceeds 10, it may be insufficient to provide flavor and efficacy of citron vinegar.

The pickling solution is preferably composed of 30-35 wt % of soy sauce, 10-20 wt % of sugar, 10-20 wt % of fermented Korean plum liquid, 5-10 wt % of alcohol, and 15-25 wt % of mixed vinegar based on the total weight thereof.

Based on the total weight of the pickling solution, if the amount of soy sauce is less than 30 wt %, long-term storage of pickles may be difficult, whereas if it exceeds 35 wt %, the salinity of pickles may increase. Also, if the amount of sugar is less than 10 wt % or greater than 20 wt %, sweetness may be weak or strong, which may affect the taste.

If the amount of fermented Korean plum liquid is less than 10 wt %, sugar has to be used in a large amount to give a sweet taste, whereas if it exceeds 20 wt %, taste and flavor of fermented Korean plum liquid may be strong, which may affect palatability.

Alcohol may contain ethanol at a concentration of 10 to 50% (W/W), preferably 15 to 30% (W/W). Alcohol, along with mixed vinegar, enables long-term storage of the pickling solution without boiling. Also, alcohol improves sensory properties by suppressing generation of off-taste and off-flavor. If the amount of alcohol is less than 5 wt %, the resulting pickles may deteriorate, whereas if it exceeds 10 wt %, unique taste of pickles cannot be obtained.

Based on the total weight of the pickling solution, if the amount of mixed vinegar is less than 15 wt %, the effect of vinegar may be insignificant, making it difficult to achieve long-term storage, whereas if it exceeds 25 wt %, the sour taste may be excessive, losing value as a food.

Such a pickling solution is preferably prepared by aging at a temperature of 20 to 25° C. for 24 to 72 hours.

### (4) Step 4: Preparation of Low-Salt Pickles (S40)

In step 4, low-salt pickles are prepared through secondary pickling by mixing the pickled intermediate of step 2 with the pickling solution of step 3 and performing aging.

Mixing the pickled intermediate with the pickling solution is to store pickles for a long period of time and to attain optimal flavor. Low-salt pickles are preferably prepared by mixing 100 parts by weight of the pickled intermediate with 50 to 100 parts by weight of the pickling solution.

Low-salt pickles are preferably obtained through two aging processes, particularly primary aging at a temperature of 20 to 30° C. for 2 to 7 days and secondary aging at a temperature of 0 to 10° C. for 90 to 100 days. The primary aging maintains the texture of food materials for pickles that constitute the pickled intermediate, and the secondary aging promotes fermentation to achieve rich flavor and low salt content.

The low-salt pickles thus prepared are storable for a long period of time, have a crispy texture, and have rich flavor and low salt content, and are thus beneficial to health. Therefore, such low-salt pickles may be used by various people without objection.

Low-salt pickles may be consumed as is or further processed and used for many purposes. Specifically, pickle solids (food materials for pickles) obtained from the low-salt pickles may be dried and pulverized to provide a dry product in powder form. Pickle solids may be obtained by filtering the low-salt pickles. The dry product may be used as a material for rice balls or Bibimbap, and may be used as a pizza topping or garnish for noodles.

Pickle solids may be dried with a water content of 10-15% (w/w) at a temperature of 40-50° C. to preserve color and flavor. The dry product may be vacuum-packed and provided to consumers.

The remaining solution (low-salt pickle liquid) after removal of the pickle solids is stored frozen, and may be thawed as necessary, and vacuum-packed and provided to consumers.

Consumers may purchase a dry product and a solution (low-salt pickle liquid) separately and take the same by adjusting the amounts thereof to suit their taste.

### Example 1

Vegetable broth was prepared by mixing 100 g of bay leaves, 200 g of green onion roots, and 200 g of red pepper seeds, followed by addition to 3 kg of water and boiling at a temperature of 100° C. for 20 hours.

A pickled intermediate was prepared through primary pickling by adding Cirsium setidens to the vegetable broth, the temperature of which was maintained at 40° C., to the extent of being submerged, followed by aging for 7 days.

A pickling solution was prepared by mixing 30 g of soy sauce, 20 g of sugar, 20 g of fermented Korean plum liquid (obtained by mixing Korean plum and sugar in a weight ratio of 1:1 and performing fermentation), 10 g of alcohol (30% ethanol), and 20 g of mixed vinegar (including citron vinegar and apple cider vinegar in a weight ratio of 1:9), followed by aging at a temperature of 25° C. for 24 hours.

Low-salt pickles were prepared through secondary pickling by mixing 1 kg of the pickled intermediate with 1 kg of the pickling solution, followed by aging at a temperature of 30° C. for 5 days.

### Example 2

Low-salt pickles were prepared in the same manner as in Example 1, with the exception that the pickling solution was prepared by mixing 30 g of low-salt soy sauce (made using fermented soybean lumps shaped after mixing 100 g of boiled mashed soybeans with 10 g of Helianthus tuberosus powder and 20 g of fermented soybean powder, salinity: 2%), 20 g of sugar, 20 g of fermented Korean plum liquid (obtained by immersing 300 g of Korean plum in 1 liter of a mixed solution of Bacillus amyloliquefaciens culture fluid (LA medium, 1×10⁷ CFU/ml), microcrystalline cellulose, and dextrin in a ratio of 7:2:1 and then performing fermentation at 25° C. for 30 days), 10 g of alcohol (30% ethanol), and 20 g of mixed vinegar (including citron vinegar and apple cider vinegar in a weight ratio of 1:9).

### Comparative Example 1

Low-salt pickles were prepared in the same manner as in Example 1, with the exception that sugar was added in an amount of 40 g, without fermented Korean plum liquid.

### Comparative Example 2

Low-salt pickles were prepared in the same manner as in Example 1, with the exception that 20 g of citron vinegar was used, in lieu of mixed vinegar.

### <Experimental Example 1> Confirmation of Sensory Test

### 1. Experimental Method

Examples 1 and 2 and Comparative Examples 1 and 2 were subjected to a sensory test. A sensory test was conducted on 30 evaluators, and sensory evaluation was carried out on the taste, flavor, and overall palatability of pickles, and the results thereof are shown in Table 1 below.

As such, after evaluation by a 5-point scale method, the average value thereof was calculated and judged. Here, the higher the score for each item, the higher the palatability for the item.

### 2. Experimental Result

TABLE 1

| | Taste | Flavor | Overall palatability |
|---|---|---|---|
| Example 1 | 4.7 | 4.8 | 4.4 |
| Example 2 | 4.5 | 4.7 | 4.3 |
| Comparative Example 1 | 3.5 | 3.5 | 3.0 |
| Comparative Example 2 | 2.0 | 2.0 | 2.5 |

As confirmed in Table 1, palatability of the low-salt pickles of Examples 1 and 2 was higher than that of Comparative Examples 1 and 2, indicating that the low-salt pickles of the present invention can be used by anyone regardless of gender or age without objection.

As is apparent from the above description, according to the present invention, low-salt pickles can be improved in palatability because long-term storage is possible, flavor is good, and salinity is low. Therefore, low-salt pickles of the present invention can be used by various people without objection, and are beneficial to health due to low sodium content.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of preparing low-salt pickles using citron vinegar, comprising:
(1) preparing vegetable broth by boiling bay leaves, green onion roots, and red pepper seeds in water and performing filtration;
(2) preparing a pickled intermediate through primary pickling by adding food materials for pickles to the vegetable broth, a temperature of which is maintained at 40 to 50° C., and performing aging for 5 to 10 days;
(3) preparing a pickling solution by mixing soy sauce, sugar, fermented Korean plum liquid, alcohol, and mixed vinegar and performing aging; and
(4) preparing low-salt pickles through secondary pickling by mixing the pickled intermediate with the pickling solution and performing aging.

2. The method according to claim 1, wherein the mixed vinegar comprises citron vinegar and apple cider vinegar.

3. Low-salt pickles using citron vinegar prepared by the method according to claim 1.

4. A dry low-salt pickle product using citron vinegar prepared by drying and pulverizing pickle solids obtained from the low-salt pickles according to claim 3.

5. A low-salt pickle solution using citron vinegar prepared by obtaining a remaining liquid after removal of pickle solids from the low-salt pickles according to claim 3.
